(19) United States
(12) Patent Application Publication
(10) Pub. No.: US 2020/0402339 A1
(43) Pub. Date: Dec. 24, 2020

(54) AUTOMATIC TELLER MACHINE, COVER OF AUTOMATIC TELLER MACHINE, AND TERMINAL DEVICE

(71) Applicant: NEC Corporation, Minato-ku, Tokyo (JP)

(72) Inventors: Tatsuro HOSOKAWA, Tokyo (JP); Jun KONDO, Tokyo (JP); Naoki MORISHITA, Tokyo (JP); Yutaro KITAHATA, Tokyo (JP)

(73) Assignee: NEC Corporation, Minato-ku, Tokyo (JP)

(21) Appl. No.: 16/771,917

(22) PCT Filed: Oct. 24, 2018
(86) PCT No.: PCT/JP2018/039573

§ 371 Date: Jun. 11, 2020

(30) Foreign Application Priority Data
Dec. 12, 2017 (JP) 2017-238098

(51) Int. Cl. G07D 11/40; G07D 9/00

(52) U.S. Cl. CPC G07D 11/40; G07D 9/00

(57) ABSTRACT

An automatic teller machine includes: a main body having an operation unit that receives operations by a user for depositing and paying cash; and a cover including a pair of side plates that laterally sandwich the main body, such that opposing surfaces of the pair of side plates are formed as curved surfaces that, together, enclose a space including the operation unit.

### TECHNICAL FIELD

The present embodiment relates to an automatic teller machine, a cover for an automatic teller machine, and a terminal device.

### BACKGROUND ART

As an automatic teller machine of this type, the automatic teller machine described in Patent Document 1 is known.

This automatic teller machine comprises a front panel having a passbook slot, a card/receipt slot, a call button and the like provided on the upper front surface of the device body; and an operation table that is provided so as to protrude forward under the front panel and on an intermediate portion of the device body.

On the far side of the operation table contacting the front panel, a paper bill slot for depositing paper bills, a coin slot for depositing coins and the like are provided. Additionally, on the front side of the operation table located on the side towards the user, additional equipment installation space for a touch panel-type operation display unit, a handset or the like, a customer sensor, and a keyhole or the like to be operated by an attendant or the like are provided.

Additionally, a cover is installed on the front surface of the above-mentioned automatic teller machine. This cover has side plates covering the operation unit from the sides, and an upper plate covering the operation unit from above. The side plates and the upper plate surround the operation unit from the periphery thereof, thereby preventing screen operations and the like from being seen from the outside.

### CITATION LIST

### Patent Literature

### Patent Document 1

Japanese Unexamined Patent Application, First Publication No. 2003-331338

### SUMMARY OF INVENTION

### Problem to be Solved by the Invention

However, the cover for the automatic teller machine described in Patent Document 1 simply covers the spaces to the sides with vertical flat plates. Therefore, the cover does not have a structure that blocks gazes from behind the user.

Thus, when used in a convenience store, a railway station or the like, the further addition of surrounding gazes induces a feeling of insecurity in the user.

The purpose of this invention, in consideration of the above-mentioned problem, is to provide an automatic teller machine, a cover for an automatic teller machine, and a terminal device that can make a user feel safe and secure.

### Means for Solving the Problem

An automatic teller machine according to a first mode includes a main body having an operation unit that receives operations by a user for depositing and paying cash; and a cover including a pair of side plates that laterally sandwich the main body, such that opposing surfaces of the pair of side plates are formed as curved surfaces that, together, enclose a space including the operation unit.

An automatic teller machine according to a second mode is the automatic teller machine according to the first mode, further having an upper plate covering the space including the operation unit from above; wherein the length, in a depth direction, of a central portion of the upper plate is shorter than the lengths at left and right end portions.

An automatic teller machine according to a third mode is the automatic teller machine according to the first or second mode, wherein the opposing surfaces are curved forward from the operation unit.

An automatic teller machine according to a fourth mode is the automatic teller machine according to any one of the first to third modes, wherein the opposing surfaces are spaced apart from each other in front of the operation unit.

An automatic teller machine according to a fifth mode is the automatic teller machine according to any one of the first to fourth modes, wherein the side plates are translucent.

A cover for an automatic teller machine according to a sixth mode is a cover for an automatic teller machine comprising a main body having an operation unit that receives operations by a user for depositing and paying cash, wherein the cover includes a pair of side plates that laterally sandwich the main body, such that opposing surfaces of the pair of side plates are formed as curved surfaces that, together, enclose a space including the operation unit.

The cover for an automatic teller machine according to a seventh mode is a cover according to the sixth mode, further having an upper plate covering the space including the operation unit from above; and wherein the length, in a depth direction, of a central portion of the upper plate is shorter than the lengths at left and right end portions.

A terminal device according to an eighth mode includes a main body having an operation unit that receives operations by a user; and a cover including a pair of side plates that laterally sandwich the main body, such that opposing surfaces of the pair of side plates are formed as curved surfaces that, together, enclose a space including the operation unit.

### Advantageous Effects of Invention

According to the present embodiment, it is possible to provide an automatic teller machine, a cover for an automatic teller machine, and a terminal device that can make a user feel safe and secure.

### BRIEF DESCRIPTION OF DRAWINGS

FIG. 1 is a perspective view illustrating the minimum structure of an automatic teller machine according to a first embodiment.

FIG. 2 is a detailed perspective view illustrating the automatic teller machine according to a second embodiment.

FIG. 3 is a side view of FIG. 2.

FIG. 4 is a plan view of FIG. 2.

FIG. 5 is a perspective view illustrating another minimum structure of an automatic teller machine according to a third embodiment.

FIG. 6 is a perspective view illustrating the minimum structure of a cover according to a fourth embodiment.

FIG. 7 is a perspective view illustrating another minimum structure of a cover according to a fifth embodiment.

### DESCRIPTION OF EMBODIMENTS

### First Embodiment

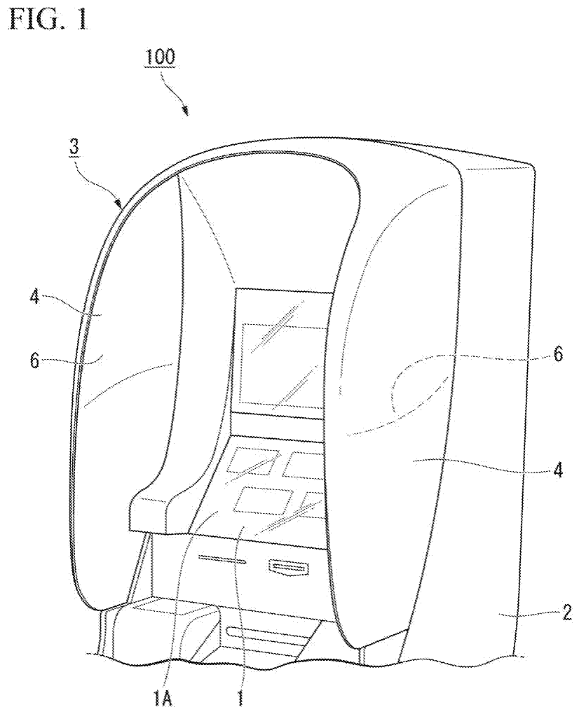

A first embodiment will be explained with reference to FIG. 1. The first embodiment is an embodiment having the minimum structure of the automatic teller machine.

As illustrated in FIG. 1, the automatic teller machine 100 in the present embodiment comprises a main body 2 having an operation unit 1 that can be operated to deposit and pay cash, and a cover 3 that sandwiches a space 1A including the operation unit 1 from the periphery thereof.

Hereinafter, the direction that the front surface of the automatic teller machine 100 faces, i.e., the direction in which the main body 2 faces the user operating the operation unit 1, is defined as forward. Relative to the forward direction defined in this way, the horizontal directions from the main body 2 are defined as the lateral directions, the direction up from the main body 2 is defined as upward, and the direction down from the main body 2 is defined as downward. Additionally, the direction opposite to the forward direction is referred to as the rearward direction. Furthermore, the forward-rearward direction relative to the main body 2 is also referred to as the depth direction, and the lateral direction relative to the main body is also referred to as the left-right direction.

The cover 3 has a pair of side plates 4 that laterally sandwich the space 1A including the operation unit 1.

The side plates 4 cover the space 1A. The side plates 4 extend forward from the main body 2 so as to obstruct gazes from outside the space 1A.

The pair of side plates 4 respectively have opposing surfaces 6 that face each other.

The opposing surfaces 6 of the pair of side plates 4 are curved surfaces that, together, enclose the space 1A including the operation unit 1. The central portions of the opposing surfaces 6 are curved so as to curve away from each other, laterally outwards from the space 1A.

The automatic teller machine 100 configured as above is provided with a cover 3 having a pair of side plates 4 that laterally sandwich the space 1A, and the opposing surfaces 6 of this pair of side plates 4 are curved surfaces that enclose the space 1A. Since the curved surfaces are curved, the space 1A is made larger in comparison to the case in which the surfaces are flat. Therefore, the cover 3 does not reduce the ease of operation by a user of the automatic teller machine 100 in the space 1A. Meanwhile, since the curved surfaces enclose the space 1A, the cover 3 is able to block gazes from outside the space 1A into the space 1A in comparison to the case in which the surfaces are flat.

Thus, the cover 3 has a structure in which the ease of operation by a user of the automatic teller machine 100 is not reduced, while also having a structure in which gazes from outside the space 1A are easily obstructed.

Therefore, a user can be made to feel safe and secure.

### Second Embodiment

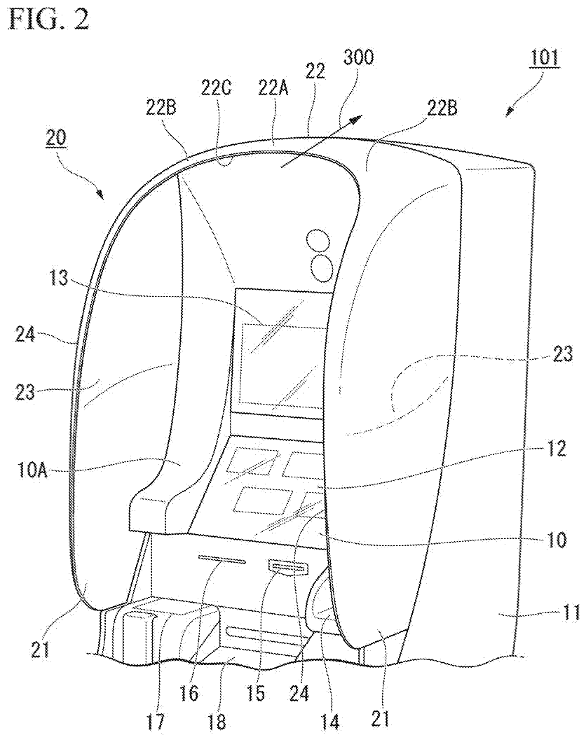

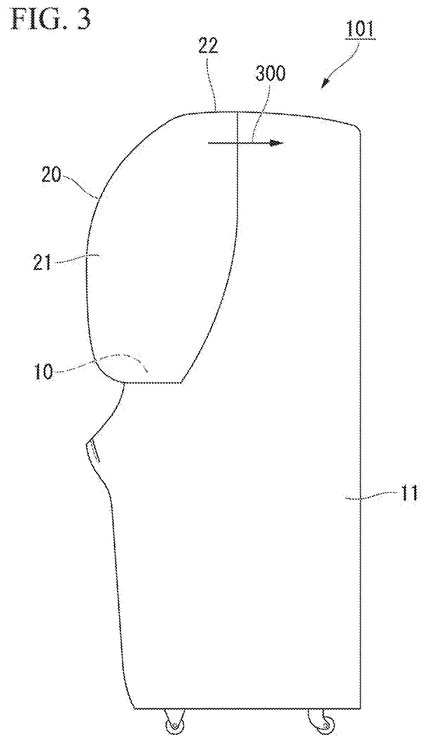

A second embodiment will be explained with reference to FIG. 2 to FIG. 4.

The automatic teller machine in the second embodiment is basically the same as that in the first embodiment, but more detailed structures are added to the main body and the cover of the first embodiment.

### (Structure of Automatic Teller Machine)

As illustrated in FIG. 2 to FIG. 4, the automatic teller machine 101 in the second embodiment comprises a main body 11 having an operation unit 10 that can be operated to deposit and pay cash, and a cover 20 that sandwiches a space 10A including the operation unit 10 from the periphery thereof.

The operation unit 10 has a first panel 12 and a second panel 13 that are provided at an upper position on the main body 11, and a tenkey pad 14, a card slot 15, a receipt slot 16, an IC card reading unit 17, a paper bill transfer slot 18 and the like, provided at an intermediary position on the main body 11.

The first panel 12 is a touch-type operation panel that is operated by the user. The second panel 13 is located above the first panel 12 and is a presentation display indicating that the machine is an automatic teller machine and also indicating information regarding the cards that can be used and the like.

There may be, installed inside the main body 11, a data processing device, a paper bill processing unit that loads and removes paper bills with respect to the paper bill transfer slot 18 based on signals from the data processing device, a printing device that prints receipts to be ejected from the receipt slot 16, and the like. The data processing device processes information input by means of the first panel 12, the tenkey pad 14 and the IC card reading unit 17.

### (Cover)

The detailed structure of the cover will be explained.

The cover 20 has a pair of side plates 21 that laterally sandwich the space 10A, and an upper plate 22 that is connected to the side plates 21 and that is located above the space 10A. Due to the side plates 21 and the upper plate 22, the cover 20 covers the space 10A.

The pair of side plates 21 respectively have opposing surfaces 23 that face each other. The side plates 21 extend forward from the main body 11 so as to obstruct gazes from outside the space 10A.

The side plates 21 are made translucent by using frosted glass, a translucent resin, a mesh material or the like.

The side plates 21 have edge portions 24 at the front. The pair of side plates 21 are arranged so that the edge portions 24 are spaced apart from each other. Thus, the opposing surfaces 23 of the pair of side plates 21 are spaced apart from each other at the front.

The directions of extension of the edge portions 24 of the pair of side plates 21 continuously change from the lower ends thereof upwards. In other words, at the lower ends, the edge portions 24 of the pair of side plates 21 extend forward. On the other hand, at upper portions thereof, the edge portions 24 of the pair of side plates 21 extend in directions towards each other.

The opposing surfaces 23 of the pair of side plates 21 are curved surfaces that, together, enclose the space 10A including the operation unit 10. The central portions of the opposing surfaces 23 are curved so as to curve away from each other, laterally outwards from the space 10A. Furthermore, the opposing surfaces 23 of the pair of side plates 21 extend forward and, together, enclose the space 10A.

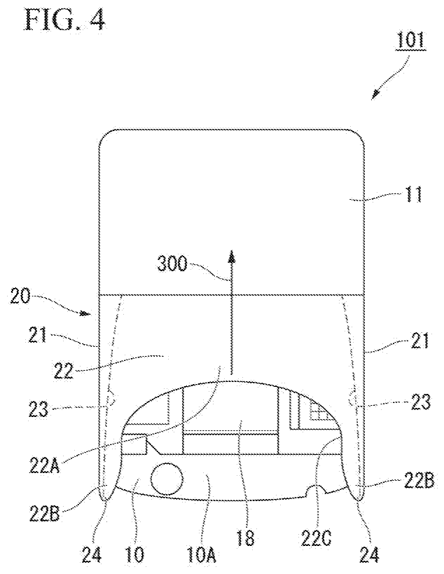

As illustrated in FIG. 4, the opposing surfaces 23 are curved forward.

The upper plate 22 has an edge portion 22C on the front side thereof. The edge portion 22C has a curved shape, and smoothly retreats rearward at a central portion 22A located at the center, in the left-right direction, of the upper plate 22. Thus, the central portion 22A of the upper plate 22 is set so as to have shorter dimensions in the depth direction (the direction of the arrow 300) than left and right end portions 22B located respectively at the left and right ends of the upper plate 22.

In the present embodiment, the upper plate 22 is made translucent by using frosted glass, a translucent resin, a mesh material or the like.

The upper plate 22 encloses the space 10A. The upper plate 22 is provided more for the purpose of imparting a sense of security to a user of the automatic teller machine 101 by enclosing the space 10A, than for the purpose of obstructing gazes from outside the space 10A.

### (Functions and Effects)

In the present embodiment, the automatic teller machine 101 comprises a cover 20 including a pair of side plates 21 that laterally sandwich the space 10A, wherein opposing surfaces 23 on the pair of side plates 21 are curved surfaces that, together, enclose the space 10A including the operation unit 10.

Thus, the cover 20 has a structure in which the ease of operation by a user of the automatic teller machine 101 is not reduced, while also having a structure in which gazes from outside the space 10A are easily obstructed.

Therefore, a user can be made to feel safe and secure.

The cover 20 further has an upper plate 22. Thus, the cover 20 further encloses the space 10A, and can make a user feel even more safe and secure.

The edge portions 24 of the pair of side plates 21 extend forward at the lower ends thereof. Thus, an even greater sense of freedom can be imparted to a user when working in the space 10A.

Meanwhile, the edge portions 24 of the pair of side plates 21 extend towards each other at upper portions thereof. Thus, the cover 20 further encloses the space 10A, and can make a user feel even more safe and secure.

In the present embodiment, the opposing surfaces 23 of the pair of side plates 21 of the cover 20 are spaced apart from each other at the front. Thus, a user can approach the operation unit 10 through the spaced area.

Therefore, the cover 20 can obstruct gazes from outside the space 10A without reducing the ease of operation by a user of the automatic teller machine 101.

Additionally, on the cover 20, the central portion 22A of the upper plate 22 is shorter, in the depth direction, than the left and right end portions 22B are. Thus, the edge portion 22C of the upper plate 22 retreats rearward at the central portion 22A. Therefore, the space above the cover 20 is opened up and the sense of confinement in the users can be lessened.

Furthermore, the edge portion 22C of the upper plate 22 retreats smoothly rearward at the central portion 22A, so a user can approach the operation unit 10, and gazes from outside the space 10A can be obstructed. Thus, the cover 20 can make a user feel safe and secure.

In the present embodiment, since the pair of side plates 21 are translucent, it is possible to let in ambient light while also obscuring the operation unit 10 and the hands of the user. Thus, the cover 20 can obstruct gazes from outside. Meanwhile, the cover 20 has enough transparency that it is possible to observe shadows in the space from the outside, allowing the user to feel safe and secure.

Additionally, since the upper plate 22 is translucent, the cover 20 is able to let in ambient light, thereby brightening the operation unit 10 and the hands of the user. Thus, the cover 20 can ensure ease of operation by a user of the automatic teller machine 101, while also allowing the user to feel safe and secure.

### Modified Example 1

In the present embodiment, curved surfaces are provided on the opposing surfaces 23 of the side plates 21 and an edge portion 22C is provided on the front side of the upper plate 22. However, as a modified example, it is possible to provide just one of the above.

### Modified Example 2

In the present embodiment, the entire surfaces of the opposing surfaces 23 of the side plates 21 were formed from curved surfaces. However, as a modified example, just portions of the opposing surfaces 23 of the side plates 21 may be formed from curved surfaces.

### Modified Example 3

As a modified example of the present embodiment, the lower surface of the upper plate 22 of the cover 20 may be formed from a curved surface similar to those of the opposing surfaces 23 of the side plates 21. Furthermore, the lower surface of the upper plate 22 may be formed so as to curve left-right and forward-rearward in the upward direction from the space 10A, and may be smoothly continuous with the opposing surfaces of the side plates 21. Thus, the entire inner peripheral surface of the cover 20 forming the space 10A can be formed from a curved surface.

### Modified Example 4

In the present embodiment, regarding the upper plate 22 of the cover 20, the edge portion 22C was formed by making the entire central portion 22A retreat, but the embodiment is not limited thereto. The edge portion 22C may be formed by making part of the central portion 22A retreat.

### Modified Example 5

In the present embodiment, the cover 20 is formed from a pair of side plates 21 that laterally sandwich the space 10A of the operation unit 10, and an upper plate 22 that is located above the space 10A. As a modified example, partitions may be formed by extending the side plates 21 of the cover 20 downward below the operation unit 10. As another modified example, instead of the cover 20, it is possible to separately provide partition plates that protrude towards the front from both sides of the main body 11.

### Modified Example 6

In the present embodiment, the side plates 21 and the upper plate 22 of the cover 20 are translucent. As a modified example, the side plates 21 and the upper plate 22 of the cover 20 may be made translucent and provided with the same color as or with a different color from the main body 11. In this case, the color of the side plates 21 of the cover 20 and the color of the upper plate 22 may be made different. As another modified example, the side plates 21 and the upper plate 22 of the cover 20 may be non-translucent, i.e., transparent or opaque.

### Third Embodiment

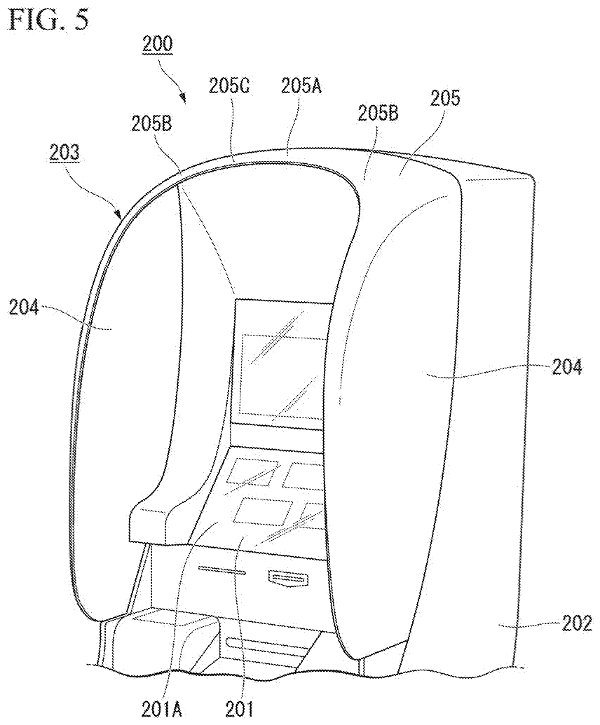

A third embodiment will be explained with reference to FIG. 5. The automatic teller machine in the third embodiment is basically the same as the first embodiment and the second embodiment, but represents a minimum structure of the automatic teller machine in an aspect different from that of the first embodiment.

As illustrated in FIG. 5, the automatic teller machine 200 in the third embodiment comprises a main body 202 having an operation unit 201 that can be operated by a user to deposit and pay cash, and a cover 203.

The cover 203 has a pair of side plates 204 that laterally sandwich the main body 202 of the automatic teller machine 200, and an upper plate 205 that covers the space 201A including the operation unit 201 from above.

The upper plate 205 has an edge portion 205C on the front side thereof. The edge portion 205C has a curved shape, and smoothly retreats rearward at a central portion 205A located at the center, in the left-right direction, of the upper plate 205. Thus, the central portion 205A of the upper plate 205 is set so as to be shorter in the depth direction (the direction of the reference sign 300) than left and right end portions 205B located respectively at the left and right ends of the upper plate 205.

The opposing surfaces of the pair of side plates 204 may be curved surfaces or may be flat surfaces.

With the central portion 205A of this upper plate 205, the cover 203 is opened in the upward direction, thereby lessening the sense of confinement in the users of the automatic teller machine 200. Furthermore, the edge portion 205C of the upper plate 205 retreats smoothly rearward at the central portion 205A, so the user can approach the operation unit 201, and gazes from outside the space 201A can be obstructed.

Therefore, the cover 203 can make a user feel more safe and secure.

### Fourth Embodiment

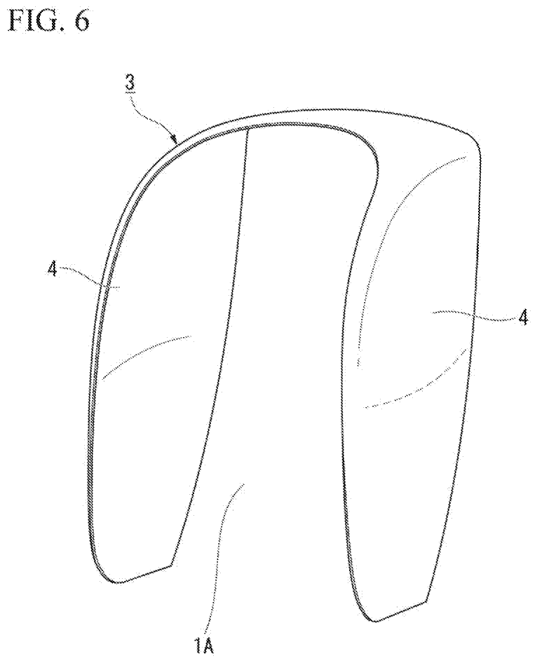

A fourth embodiment will be explained with reference to FIG. 6. The fourth embodiment is an embodiment with the minimum structure of the cover. The cover in the fourth embodiment has basically the same structure as the cover 3 in the first embodiment.

As illustrated in FIG. 6, the cover 3 of the present embodiment is a cover for an automatic teller machine and includes a pair of side plates 4 that laterally sandwich the main body of the automatic teller machine. Opposing surfaces on the pair of side plate 4 are curved surfaces that extend forward and, together, enclose a space 1A.

Thus, the cover 3 has a structure that makes it easy to obstruct gazes from outside the space 1A without reducing the ease of operation by a user of the automatic teller machine.

Therefore, the cover 3 can make a user feel safe and secure.

### Fifth Embodiment

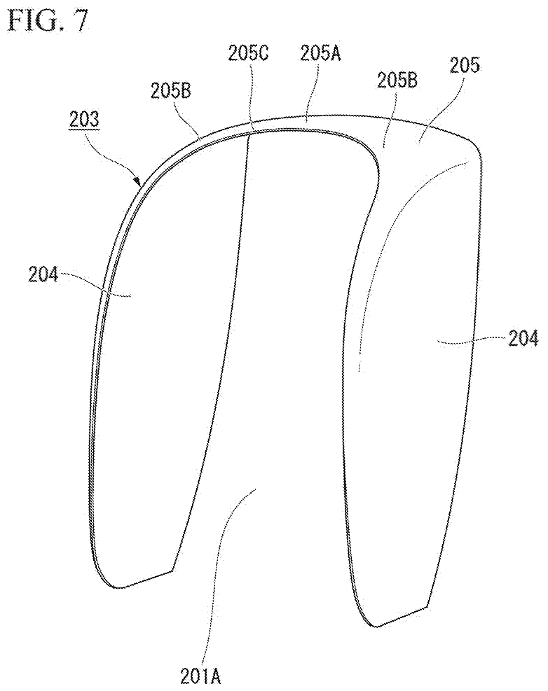

A fifth embodiment will be explained with reference to FIG. 7. The fifth embodiment is an embodiment with another minimum structure of the cover. The cover in the present embodiment has basically the same structure as the cover 203 in the third embodiment.

As illustrated in FIG. 7, the cover 203 in the fifth embodiment is a cover for an automatic teller machine, the cover having a pair of side plates 204 that laterally sandwich the main body of the automatic teller machine, and an upper plate 205 that covers a space including the operation unit from above.

The upper plate 205 has an edge portion 205C on the front side thereof. The central portion 205A located at the center of the upper plate 205 is set so as to have shorter dimensions in the depth direction than the left and right end portions 205B located respectively at the left and right ends of the upper plate 205.

With the central portion 205A of this upper plate 205, space is opened in the upward direction, thereby lessening the sense of confinement in the user while also allowing the user to approach closer to the operation unit due to the further depth. Thus, the cover 203 is able to realize a structure in which gazes from outside the space 201A can be easily obstructed without reducing the ease of operation by users of the automatic teller machine.

Therefore, the cover 203 can make a user of the automatic teller machine feel more safe and secure.

Whereas embodiments of the present embodiment have been explained in detail above with reference to the drawings, the specific structure is not limited to these embodiments and design modification and the like are included within a range not departing from the spirit of the present embodiment

For example, the above-mentioned embodiments are cases in which the embodiment is applied to an automatic teller machine, but the embodiment may also be applied to terminal devices other than automatic teller machines. In other words, as a modified example, a terminal device may be provided with a main body 2, 11, 202 having an operation unit that can be operated by a user, and a cover 3, 20, 203.

Priority is claimed on Japanese Patent Application No. 2017-238098, filed Dec. 12, 2017, the entire disclosure of which is incorporated herein by reference.

### INDUSTRIAL APPLICABILITY

According to the present embodiment, a user can be made to feel safe and secure.

### REFERENCE SIGNS LIST

1 Operation unit
1A Space
2 Main body
3 Cover
4 Side plate
6 Opposing surface
10 Operation unit
10A Space
11 Main body
12 First panel
13 Second panel
14 Tenkey pad
15 Card slot
16 Receipt slot
17 IC card reading unit
18 Paper bill transfer slot
20 Cover
21 Side plate
22 Upper plate
22A Central portion
22B Left/right end portion
22C Edge portion
23 Opposing surface
24 Edge portion
100 Automatic teller machine
101 Automatic teller machine
200 Automatic teller machine
201 Operation unit
201A Space
202 Main body
203 Cover
204 Side plate
205 Upper plate
205A Central portion
205B Left/right end portion
205C Edge portion

What is claimed is:

1. An automatic teller machine comprising:
a main body having an operation unit that receives operations by a user for depositing and paying cash; and
a cover including a pair of side plates that laterally sandwich the main body, such that opposing surfaces of the pair of side plates are formed as curved surfaces that, together, enclose a space including the operation unit.

2. The automatic teller machine according to claim 1, wherein:
the cover further has an upper plate covering the space including the operation unit from above; and wherein
the length, in a depth direction, of a central portion of the upper plate is shorter than the lengths at left and right end portions.

3. The automatic teller machine according to claim 1, wherein the opposing surfaces are curved forward from the operation unit.

4. The automatic teller machine according to claim 1, wherein the opposing surfaces are spaced apart from each other in front of the operation unit.

5. The automatic teller machine according to claim 1, wherein the side plates are translucent.

6. A cover for an automatic teller machine comprising a main body having an operation unit that receives operations by a user for depositing and paying cash, wherein:
the cover includes a pair of side plates that laterally sandwich the main body, such that opposing surfaces of the pair of side plates are formed as curved surfaces that, together, enclose a space including the operation unit.

7. The cover according to claim 6, further having an upper plate covering the space including the operation unit from above; and wherein
the length, in a depth direction, of a central portion of the upper plate is shorter than the lengths at left and right end portions.

8. A terminal device comprising:
a main body having an operation unit that receives operations by a user; and
a cover including a pair of side plates that laterally sandwich the main body, such that opposing surfaces of the pair of side plates are formed as curved surfaces that, together, enclose a space including the operation unit.
